(19) United States
(12) Patent Application Publication
(10) Pub. No.: US 2019/0335791 A1
(43) Pub. Date: Nov. 7, 2019

(54) Cooking Device and Method

(71) Applicant: Fun Eating Pty Ltd, Murarrie QLD (AU)

(72) Inventors: Bob G. Hamilton, Wynnum Central (AU); Brent McMullen, Murarrie QLD (AU)

(21) Appl. No.: 16/517,900

(22) Filed: Jul. 22, 2019

Related U.S. Application Data
(63) Continuation-in-part of application No. 15/704,267, filed on Sep. 14, 2017.

(30) Foreign Application Priority Data
Sep. 15, 2016 (AU) 2016903715

(51) Int. Cl. A23L 5/10; B65D 81/34; A23L 13/00; B65D 81/26

(52) U.S. Cl. CPC A23L 5/13; A23L 5/17; A23V 2002/00; A23L 13/00; B65D 81/261; B65D 81/3415

(57) ABSTRACT

A method for cooking meat, the method comprising: placing the meat having exudate in a suitable vacuum sealed bag; vacuum sealing the bag; placing the bag on a rack; placing the rack in a cooking device; cooking the meat, which produces exudate; removing the rack from the cooking device and cooling the meat to a temperature which is safe for handling; and sealing the bag so as to segregate the meat from the cooked exudate, wherein the rack is adapted to support the meat in an upper section of the bag whilst allowing the exudate to fall into a lower section of the bag.

### CROSS REFERENCE TO RELATED APPLICATIONS

This application is a continuation-in-part of U.S. patent application Ser. No. 15/704,267 filed on Sep. 14, 2017 which claimed priority to Australian Patent Application Number 2016903715 filed on Sep. 15, 2016, the contents of both of which said applications is herein incorporated by reference in their entirety.

### TECHNICAL FIELD

The present invention relates to cooking technology and, more particularly, to an improved method, system and apparatus for sous vide cooking.

### BACKGROUND

A cost effective way of cooking meat is in specially designed air-tight plastic bags. The bags are placed in a water bath or in a temperature-controlled steam environment. This form of cooking is called “sous vide” (French for “under vacuum”). It achieves a high yield bacterial kill whilst maintaining the flavour and tenderness of the meat. The intent is to cook the meat evenly, ensuring that the inside is properly cooked without overcooking the outside, and retaining moisture.

Meat can be cooked via the sous vide method at temperatures from as low as 45 degrees Celsius to as high as 99 degrees Celsius. The lower the temperature of cooking, the longer the duration of cooking is required to kill bacteria, yeasts and mould and to break down connective tissue and increase tenderness.

A negative effect of slow cooking using the sous vide method is the generation of liquid exudate from the meat. Exudate is produced irrespective of whether the meat is marinated or not. Consumers typically do not want to buy bagged meat which contains exudate because they are perceive that they are paying for the cost of the liquid exudate, rather than just the cost of the meat. Consequently, after meat is cooked via the sous vide method, it is customary to open the bag to facilitate removal of the exudate. The meat is then re-bagged for sale.

However, opening the bag causes the reintroduction of bacteria which contaminates the meat, drastically reducing its shelf life. A common method of dealing with the reintroduction of bacteria is to dip the re-bagged meat in water at a sufficient temperature to pasteurize the surface of the meat in the bag. This method marginally increases the shelf life of the meat. However, there is still a danger that some bacteria are not killed when the meat is re-cooked.

Another problem with the industrial application of sous vide cooking is that it generates industrial waste. The exudate and the original plastic bag used to cook the meat are commonly considered to be industrial waste. Local councils typically charge more to dispose industrial waste than standard waste. Accordingly, the disposal of the exudate and bags is an additional cost to meat cooking factories.

The exudate comprises as much as 30% of the meat. If the exudate could be recovered, it represents an opportunity for a sellable co-product for meat cooking factories. With further heat treatment, the exudate could be re-stabilised so that it could be used as a meat stock. Accordingly, there is a need for a system which is able to capture the exudate for re-sale.

The object of the invention is to at least partially overcome at least one of the abovementioned disadvantages or provide the consumer with a useful or commercial choice.

### SUMMARY OF INVENTION

According to another aspect of the present invention, there is provided a method for cooking meat, the method comprising:
(a) placing the meat in a bag adapted for vacuum sealing;
(b) vacuum sealing the bag;
(c) placing the bag on a rack configured to support the meat in an upper section of the bag whilst allowing the exudate to discharge into a lower section of the bag during cooking;
(d) placing the rack in a cooking device;
(e) cooking the meat, which produces exudate; and
(f) removing the rack from the cooking device and allowing the meat to cool to a temperature which is safe for handling.

According to another aspect of the present invention, there is provided a method for cooking meat, the method comprising:
(a) placing the meat in a bag adapted for vacuum sealing;
(b) vacuum sealing the bag;
(c) placing the bag on a rack;
(d) placing the rack in a cooking device;
(e) cooking the meat, which produces exudate;
(f) removing the rack from the cooking device and allowing the meat to cool to a temperature which is safe for handling; and
(g) sealing the bag so as to segregate the meat from the exudate, wherein the rack is adapted to support the meat in an upper section of the bag whilst allowing the exudate to discharge into a lower section of the bag.

Preferably, the method further comprises the step of cutting the bag once removed from the rack after cooking, to separate the meat from the exudate in the sealed sections of the bag. The exudate can then be disposed of and the cooked meat which is in a sealed bag, sent for sale.

More preferably, the cooking device is a steam oven. Alternatively, the cooking device may be a water immersion boiler device.

According to another aspect of the invention, there is provided a system for cooking meat, the system comprising:
(a) a suitable vacuum sealed bag for holding meat; and
(b) a rack adapted to be placed in a cooking device;
wherein the rack is configured to support the meat, but allow exudate to discharge from the meat into a lower section of the bag whilst in the cooking device.

Preferably, the system further comprises a device adapted to separate and double seal the exudate from the meat. The device is preferably also adapted to cut between the double seal so as to cut the section of the bag containing the exudate from the section of the bag containing the meat. It is preferred that the rack has open ended supports to facilitate the removal of the bagged meat from the rack in such a way so that the exudate does not contaminate the areas of the bag to be sealed.

According to yet another aspect of the present invention, there is provided an apparatus for use in a cooking device, the apparatus comprising a rack adapted for holding a vacuum sealed bag containing food to be cooked, wherein the rack is adapted to support the food, but allow waste product to discharge from the food into a lower section of the bag whilst in the cooking device.

According to another aspect of the invention, there is provided a method for cooking meat, the method comprising:
(a) placing the meat in a bag adapted for vacuum sealing, the bag configured to support the meat in an upper section of the bag whilst allowing the exudate to discharge into a lower section of the bag during cooking;
(b) vacuum sealing the bag;
(c) hanging the bag from a rack;
(d) placing the rack in a cooking device;
(e) cooking the meat, which produces the exudate; and
(f) removing the rack from the cooking device and allowing the meat to cool to a temperature which is safe for handling.

In some embodiments, the bag may include one or more apertures. In some embodiments the bag may include two or more apertures. The two or more apertures may be evenly spaced apart. Each aperture may be suitable for receiving a hook or the alike suitable for hanging the bag from a rack.

In some embodiments, the bag may include one or more supports for separating the bag into an upper section and a lower section. The one or more supports may be suitable for supporting the meat in the upper section of the bag. Typically, the one or more supports do not extend the entire width of the bag such that exudate from the meat may drain from the upper section to the lower section of the bag when hanging.

In some embodiments, the bag may include two or more supports. The two or more supports may be evenly spaced apart. Advantageously, space between the two or more supports may allow for drainage of exudate discharged from the meat into a lower section of the bag.

Each support may be in the form of a weld. Each weld may be a spot weld.

According to another aspect of the invention, there is provided system for cooking meat, the system comprising:
(a) a suitable vacuum sealed bag for holding meat; and
(b) a rack adapted to be placed in a cooking device;
   wherein the bag is adapted to support the meat in an upper section, but allow exudate to discharge from the meat into a lower section of the bag whilst in the cooking device.

Any of the features described herein can be combined in any combination with any one or more of the other features described herein within the scope of the invention. The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 is a perspective view of a rack which forms part of a system for cooking meat according to an embodiment of the present invention.

FIG. 2 is a side view of the rack of FIG. 1.

FIG. 3 is a front view of the rack of FIG. 1.

FIG. 4 is a perspective view of meat in a vacuum sealed bag which has been placed on the rack of FIG. 1.

FIG. 5 is perspective view of the rack of FIG. 1 holding many of the bags shown in FIG. 4.

FIG. 6 is a perspective view of the rack of FIG. 5 in a steam cooking device.

FIG. 7 is a first perspective view of a device adapted to seal and separate the sections of the bag containing the meat and exudate shown in FIG. 4.

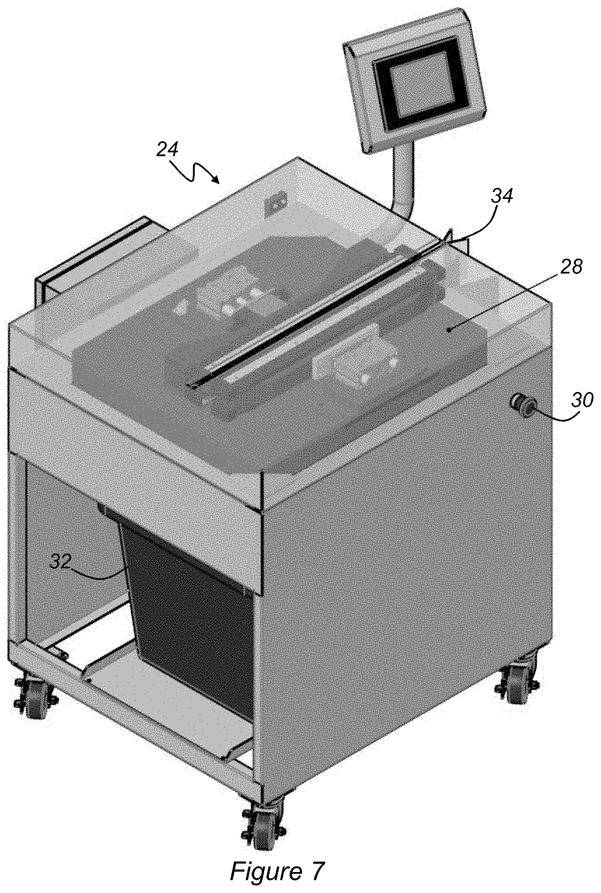

FIG. 8 is a second perspective view of the device of FIG. 7.

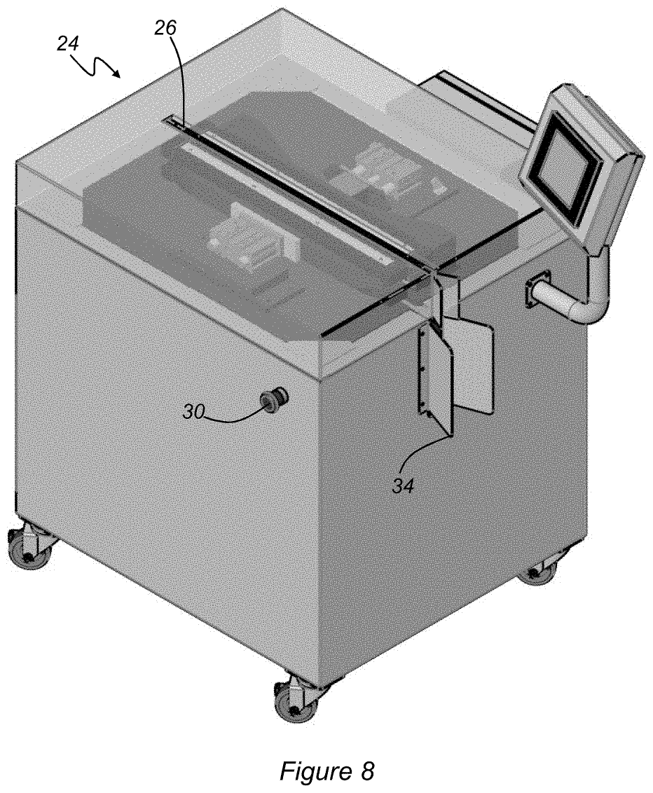

FIG. 9 is a side view of the device of FIG. 7.

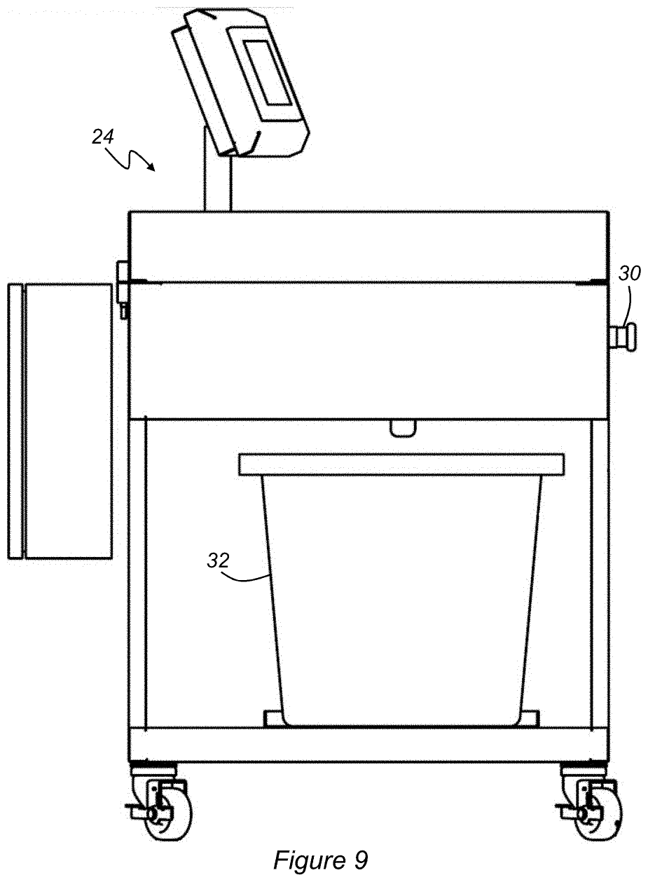

FIG. 10 shows an alternative bag to the bag shown in FIGS. 4, 5 and 6.

FIG. 11 shows the alternative bag shown in FIG. 10 with hanging hooks and enclosing a pseudo product.

FIG. 12 shows the alternative bag shown in FIG. 11 hanging via hooks.

FIG. 13 shows a close up view of the pseudo product shown in FIGS. 11 and 12.

### DETAILED DESCRIPTION

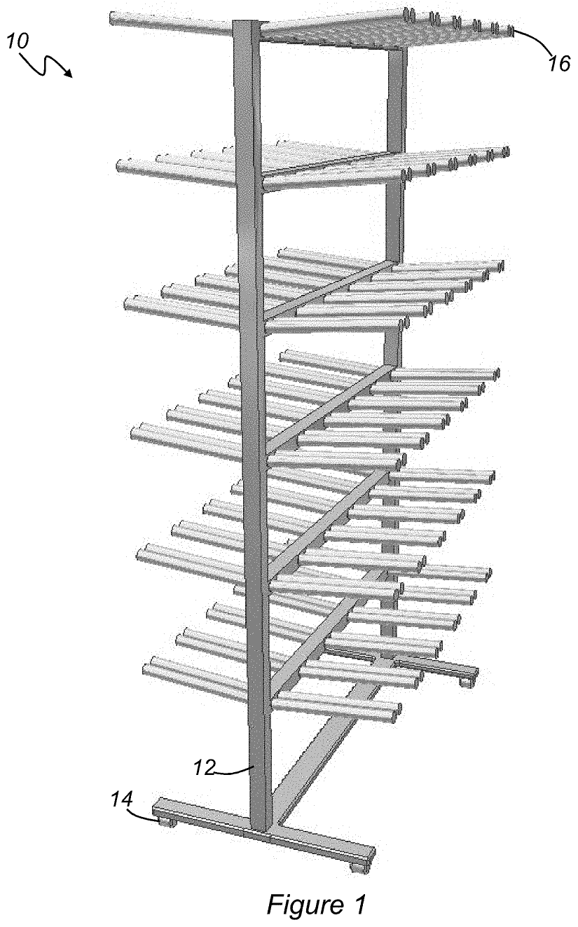

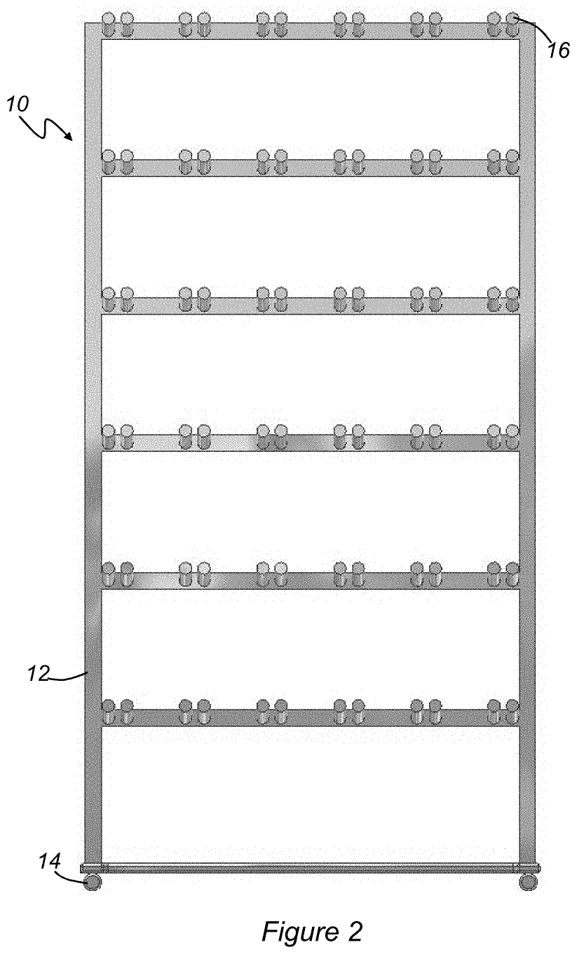

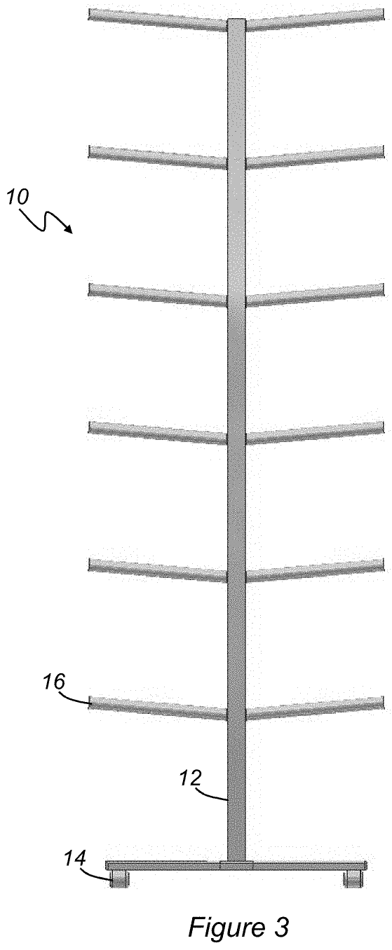

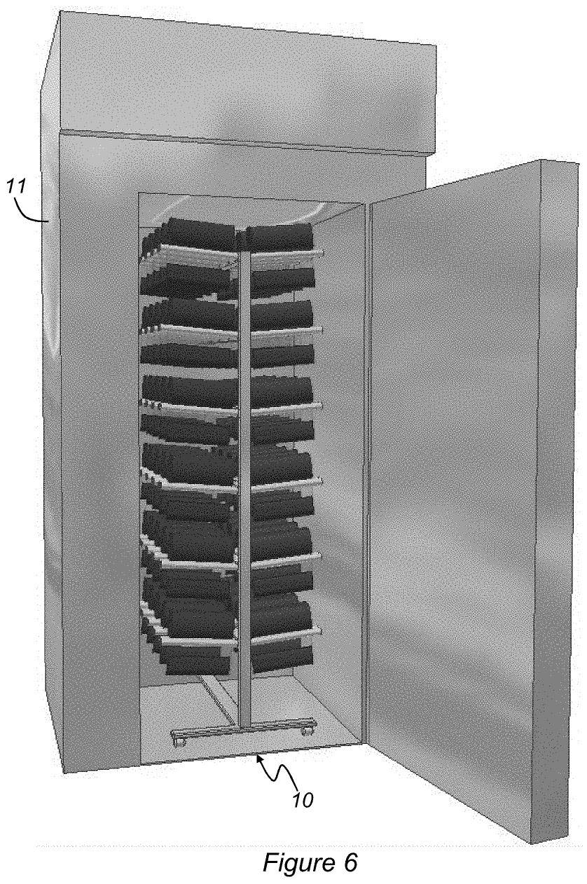

FIGS. 1 to 6 show a rack 10 according to an embodiment of the present invention. The rack 10 is adapted for use in a cooking device, such as the steam cooker 11 shown in FIG. 6. The rack 10 comprises a frame 12 on wheels 14. The frame 12 has rods 16 which act as supports for a plastic bag 18 containing meat 20 and exudate 22. The upper section of the bag 18 containing the meat 20 sits on the rods 16. The rods 16 are spaced so that the exudate 22 can discharge from the meat 20 between the rods 16 into the lower section of the bag 18.

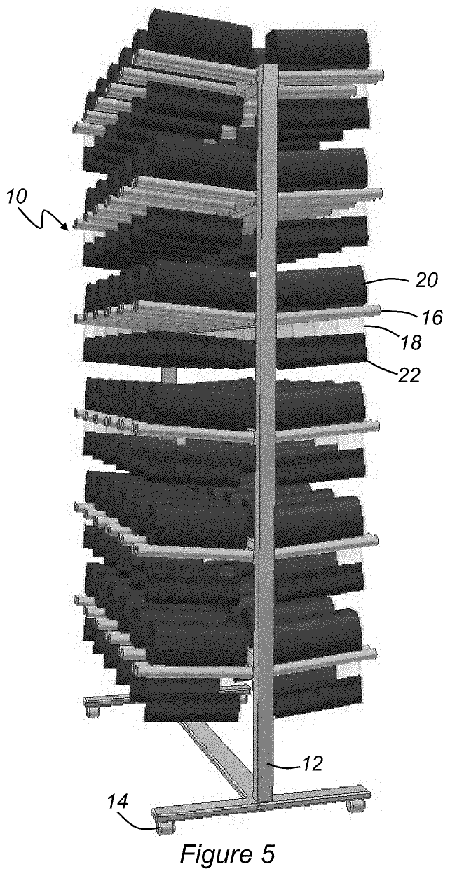

The bag 18 should be suitable for sous vide cooking. These types of bags are heat resistant and are adapted to have vacuum seal which is not affected by fats, moisture or particulates. Many bags 18 containing meat 20 are shown on the rack 10 in FIG. 5.

Once the meat 20 has been cooked in the steam cooker 11 (see FIG. 6), it is removed and allowed to cool until it is at a suitable temperature for handling. The bags 18 are then removed from the rack 10 and placed into a sealing device 24. The sealing device 24 has an aperture 26 for the bag 18. The aperture 26 is wide enough to allow the passage of the lower section of the bag 18 containing the exudate 22, but not wide enough to allow the passage of the meat 20 within the upper section of the bag 18. A heat press 28 within the sealing device 24 can be activated by a user by pressing a button 30 so as to seal the upper section of the bag 18 containing the meat 20 from the lower section of the bag 18 containing the exudate 22, thereby separating the meat 20 from the exudate 22.

The sealing device 24 further includes a blade (not shown) adapted to cut the upper section of the bag 18 containing the meat 20 from the lower section of the bag 18 containing the exudate 22. The lower section of the bag 18 drops into a bucket 32 placed within the sealing device 24. The upper section of the bag 18 can be slid out of the sealing device 24 via the exit channel 34. Thereby exudate 22 is separated from the meat 20 without opening the bag 18 to avoid the possibility of contaminating the meat. The exudate 22 is now packaged and ready for re-processing into a sellable co-product, namely meat stock.

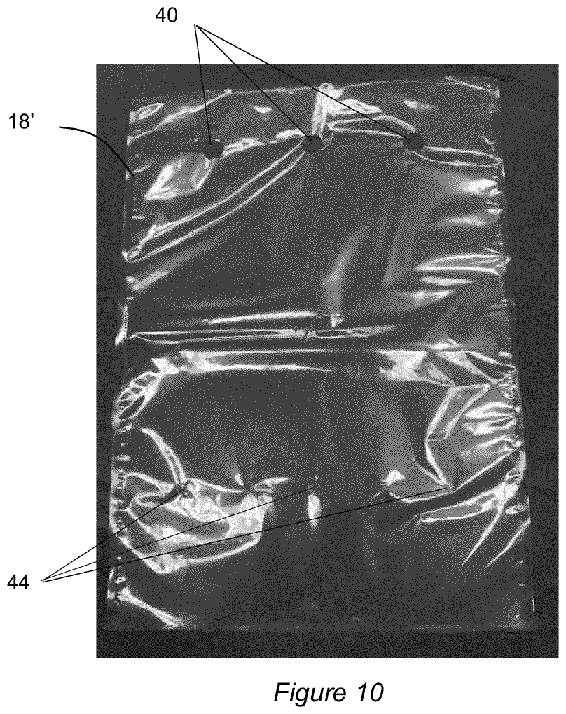

Turning to FIGS. 10 to 13, these figures show an alternative embodiment of the present invention.

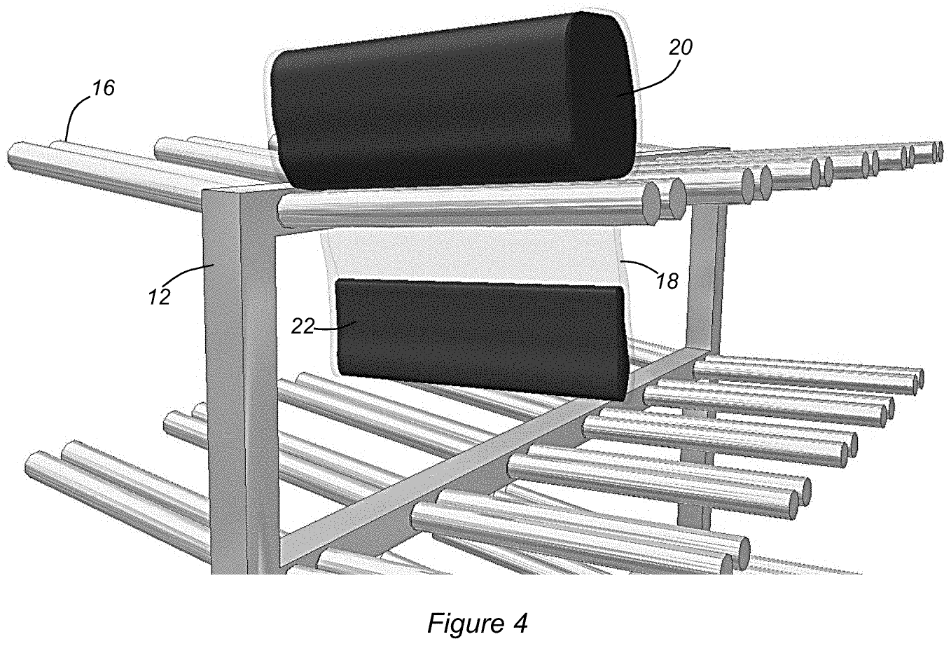

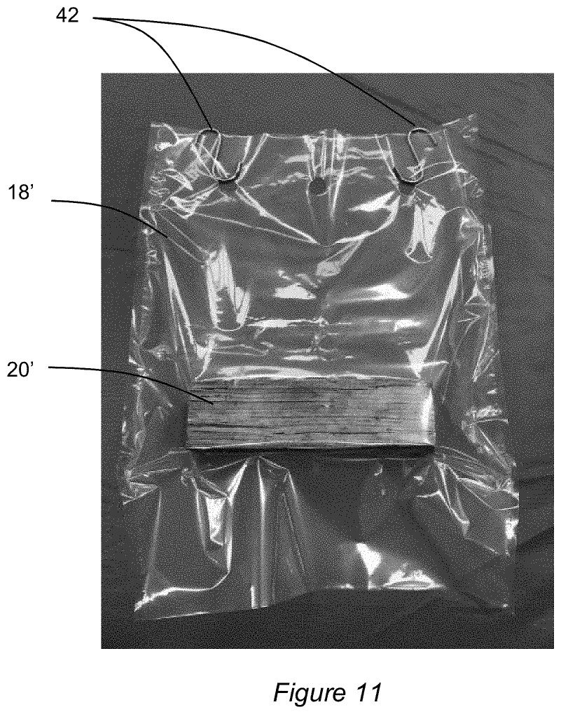

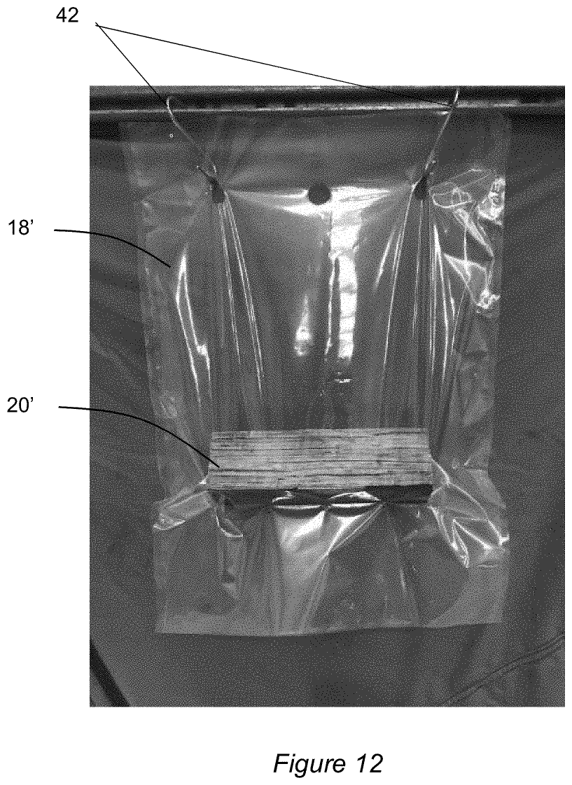

FIGS. 10 to 12, in particular, show an alterative bag 18′ to that shown in FIGS. 4 to 6. Bag 18′ includes apertures 40 each suitable for receiving a hook 42 (best shown in FIGS. 11 and 12 for hanging the bag from a rack. The rack may be the same rack as shown in FIGS. 1 to 6 or any alternative rack suitable for mounting bags 18′ thereto.

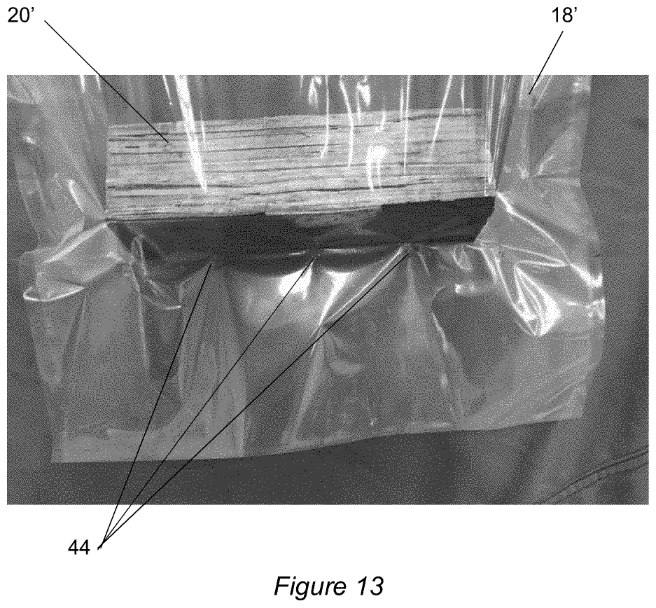

Bag 18′ further includes multiple sport welds 44 (best shown in FIG. 13). Spot welds 44 separate bag 18′ into two sections, an upper section and a lower section. The upper section of the bag 18′ contains meat 20′ which sits on spot welds 44. Spot welds 44 are spaced so that exudate can discharge from meat 20′ between the spot welds 44 into the lower section of the bag 18′.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method for cooking meat, the method comprising:
(a) placing the meat in a bag adapted for vacuum sealing;
(b) vacuum sealing the bag;
(c) placing the bag on a rack configured to support the meat in an upper section of the bag whilst allowing the exudate to discharge into a lower section of the bag during cooking;
(d) placing the rack in a cooking device;
(e) cooking the meat, which produces the exudate; and
(f) removing the rack from the cooking device and allowing the meat to cool to a temperature which is safe for handling.

2. A method for cooking meat as claimed in claim 1 further comprising the step of sealing the bag so as to segregate the meat from the exudate.

3. The method of claim 1, further comprising the step of cutting the bag to separate the meat from the exudate in sealed sections of the bag.

4. The method of claim 1, wherein the cooking device is a steam oven.

5. The method of claim 1, wherein the cooking device is a water immersion boiler device.

6. A system for cooking meat, the system comprising:
(a) a suitable vacuum sealed bag for holding meat; and
(b) a rack adapted to be placed in a cooking device;
wherein the rack is adapted to support the meat, but allow exudate to discharge from the meat into a lower section of the bag whilst in the cooking device.

7. The system of claim 6, wherein the system further comprises a device adapted to separate and seal the exudate from the meat.

8. The system of claim 7, wherein double seal is formed to seal the exudate from the meat, the double seal including two spaced apart seals.

9. The system of claim 8, wherein the device is further adapted to cut between the double seal so as to cut a section of the bag containing the exudate from a section of the bag containing the meat.

10. The system of claim 6, wherein the rack has spaced apart supports, separated at an outer end to facilitate removal of the vacuum sealed bag from the rack after cooking in such a way so that the exudate does not contaminate an areas of the bag containing the meat.

11. An apparatus for use in a cooking device, the apparatus comprising a rack adapted for holding a vacuum sealed bag containing food to be cooked, wherein the rack is adapted to support the food, but allow waste product to discharge from the food into a lower section of the bag whilst in the cooking device.

12. A method for cooking meat, the method comprising:
(a) placing the meat in a bag adapted for vacuum sealing, the bag configured to support the meat in an upper section of the bag whilst allowing the exudate to discharge into a lower section of the bag during cooking;
(b) vacuum sealing the bag;
(c) hanging the bag from a rack;
(d) placing the rack in a cooking device;
(e) cooking the meat, which produces the exudate; and
(f) removing the rack from the cooking device and allowing the meat to cool to a temperature which is safe for handling.

13. A system for cooking meat, the system comprising:
(a) a suitable vacuum sealed bag for holding meat; and
(b) a rack adapted to be placed in a cooking device;
wherein the bag is adapted to support the meat in an upper section, but allow exudate to discharge from the meat into a lower section of the bag whilst in the cooking device.
